(19) United States
(12) Patent Application Publication
(10) Pub. No.: US 2014/0094948 A1
(43) Pub. Date: Apr. 3, 2014

(54) PROCESS FOR CUTTING ONE OR MORE GLAZINGS

(71) Applicants: Antoine Peyrude, Compiegne (FR); Ulrich Billert, La Celle Saint-cloud (FR)

(72) Inventors: Antoine Peyrude, Compiegne (FR); Ulrich Billert, La Celle Saint-cloud (FR)

(73) Assignee: SAINT-GOBAIN GLASS FRANCE, Courbevoie (FR)

(21) Appl. No.: 14/122,504

(22) PCT Filed: May 22, 2012
(86) PCT No.: PCT/FR2012/051135

§ 371 Date: Dec. 18, 2013

(30) Foreign Application Priority Data
May 27, 2011 (FR) 1101653

(51) Int. Cl. G06F 17/50; G05B 19/18

(52) U.S. Cl. CPC G06F 17/50; G05B 19/182
USPC 700/106

(57) ABSTRACT

A process for cutting several pieces of glass from at least one glass sheet, includes reading information relating to defects in the at least one glass sheet; and automatically and dynamically generating an optimum cutting layout for each of the at least one glass sheet as a function of at least some of the information relating to the defects.

The present invention relates to the field of the cutting of pieces of glass from sheets of glass of large dimensions.

Glass is generally manufactured in the form of a continuous ribbon, for example a continuous ribbon of float glass or of cast glass.

This ribbon is thereafter cut up into glass sheets termed “motherglass”; which sheets are for example “PLFs” (deriving from the French for Large Format Plates of glass), typically of dimensions 3.21 m by about 6 m, or “DLFs” of dimensions about 2.55 m by 3.21 m.

A step of analyzing defects is carried out before this cutting to verify whether the glass ribbon corresponds to specifications for defects. If there are out-of-specification defects, the motherglasses are cut, excluding a certain length of the ribbon corresponding to the part of the ribbon that is out-of-specification.

As a variant, the defects are for example marked with an ink so that they can be identified subsequently without a new analysis. After cutting, the motherglasses can then be stacked in different piles according to the classes of specifications of the defects.

The motherglasses can thereafter undergo one or more conversion processes (for example deposition of a layer, lamination, etc).

After each conversion, the motherglasses are for example analyzed to detect possible defects and thus verify whether the quality corresponds to a predetermined specification. In the converse case, the motherglass is rejected.

US-A-2004/0134231 describes a process for cutting glass substrates for LCD screens from motherglasses. The motherglasses are identified and information relating to the defects of each motherglass such as the position, the size or the type of defects are stored so as to be able to optimize the cutting of LCD substrates of various sizes as a function of the information about defects of each motherglass.

Various predetermined cutting layouts are for example combined with various motherglasses and with various acceptance criteria so as to maximize the number of LCD substrates that can be cut from a set of several motherglasses.

An aim of the invention is to provide a process making it possible to further decrease the losses due to defects in the glass.

According to one aspect of the invention, it involves a process for cutting several pieces from at least one glass sheet, comprising a step of reading information relating to defects in said at least one glass sheet,

in which the process comprises:
a step of automatically generating an optimum cutting layout for each of said at least one glass sheet as a function of at least some of the information relating to the defects, the automatic generation of the optimum cutting layout being obtained by a dynamic computation;
a step of cutting the pieces of glass complying with the optimum cutting layout generated.

Note that, throughout the text, the expression “automatic” is intended to mean an action carried out by a machine executing a recorded program.

The expressions “dynamic generation” or “generation by dynamic computation” are intended to mean a construction of the cutting layout which is determined in tandem with the execution of the program. This construction leads directly and surely to the optimum cutting layout. A single cutting layout is generated.

Note also that the expression “cutting of a glass sheet” is intended to mean cutting of a bare glass sheet or one on which a coating has been deposited.

Furthermore, a glass sheet is not necessarily flat, even though it generally is during cutting.

The advantage of this process is to make it possible to yet further optimize the process for cutting pieces of glass from a glass sheet of large dimensions or from a group of several glass sheets.

According to particular embodiments, the process exhibits one or more of the following characteristics, taken in isolation or in accordance with all the technically possible combinations:
the computation is iterative;
the computation is iterated on the basis of an initial cutting layout;
the initial cutting layout is predetermined;
the dynamic computation maximizes or minimizes an objective function of several variables, the variables being subject to constraints, and the computation generates only a single cutting layout;
the objective function provides a value representative of the number of pieces of glass to be cut which includes at least one non-acceptable defect and/or is representative of a sum of one or more dimensions of these pieces of glass and/or is representative of a sum of the costs of rejecting these pieces of glass;
the objective function is linear;
the variables include variables representative of spatial coordinates of the pieces to be cut;
certain of the pieces to be cut have different dimensions, the variables including variables representative of one or more dimensions of at least some of the pieces to be cut, for example the width and/or the length in the case of a rectangle;
the variables include variables representative of one or more angles of at least some of the pieces of glass to be cut with respect to one or more references;
the variables and/or the constraints include respectively variables and/or constraints representative of acceptance criteria for allowing the defects as a function of at least some of the information about the defects;
the acceptance criteria for allowing the defects are different for various pieces of glass to be cut;
the acceptance criteria for allowing defects are different inside a predetermined zone of one, of several or of each of the pieces to be cut with respect to another predetermined zone of the same piece to be cut;
one of said predetermined zones is included in the other of said predetermined zones of the same piece of glass to be cut;
there exist at least three different acceptance criteria corresponding to at least three respective zones of one and the same piece to be cut;
three of said predetermined zones are included one in the other;
said at least one glass sheet comprises several glass sheets, the variables including for example at least one variable representative of a cutting percentage for at least one of the pieces from the group of glass sheets;
at least some of the variables can only take a finite number of values, for example all the variables;
the constraints include at least one constraint of positioning of the pieces of glass preventing the mutual overlap of the pieces of glass;
the constraints include at least one constraint of positioning of the pieces of glass inside at least one of the glass sheet or sheets;
the constraints are linear equations, representative of a convex polyhedron;
the process comprises:
   a step of analyzing the defects in said at least one glass sheet;
   a step of storing information relating to the defects detected in said at least one glass sheet, the storage being for example carried out notably by marking with ink on the defects of said at least one glass sheet or by storage in an electronic memory, the step of reading the information including for example a step of reading an ink marked on the defects of the glass or a step of reading an electronic memory containing said information.
the storage step includes a step of storing said information in one or more electronic memories;
the information is accessible by Internet or a local network;
the storage step includes a step of marking said information on the corresponding glass sheet;
the marking is carried out by an ink marking the detected defect or defects directly on the defect or defects;
the process comprises several steps of analyzing the defects;
the analysis steps are alternated with steps of storing the detected defects;
the process comprises a step of identifying the at least one glass sheet;
the identification step includes the inscribing of an identification code on the corresponding glass sheet, for example of bar-code type, and/or the reading of this code;
the information relating to the defects includes a position and/or a size and/or a type of the defects;
the computation is carried out by one or more electronic computers;
the glass sheet or sheets are cut from a continuous glass ribbon;
the glass sheet or sheets are cut from a continuous glass ribbon without rejecting a part of the glass ribbon between two consecutive glass sheets cut from the ribbon;
the pieces of glass to be cut from the at least one glass sheet are able to form at least one part of a glazing, notably a building glazing, a glazing for solar application, for example photovoltaic, a glazing for OLED application, a mirror or an automobile glazing;

The invention will be better understood on reading the description which follows, given solely by way of example and while referring to the appended drawings in which:

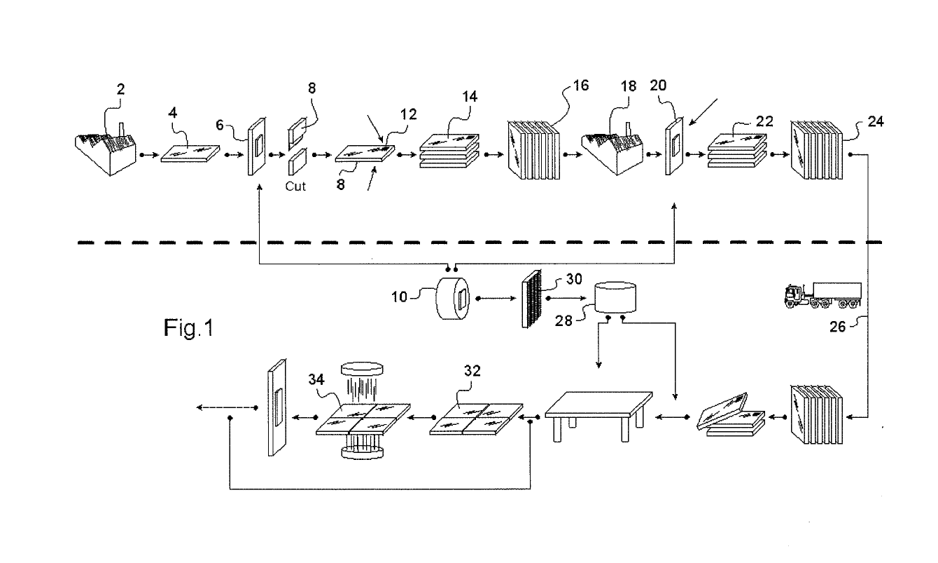

FIG. 1 is a diagram illustrating in a schematic manner an exemplary process for manufacturing building glazings, glazings for solar application, for example photovoltaic, glazings for OLED application, mirrors or automobile glazings, by illustrating the main steps as well as an exemplary logistical chain;

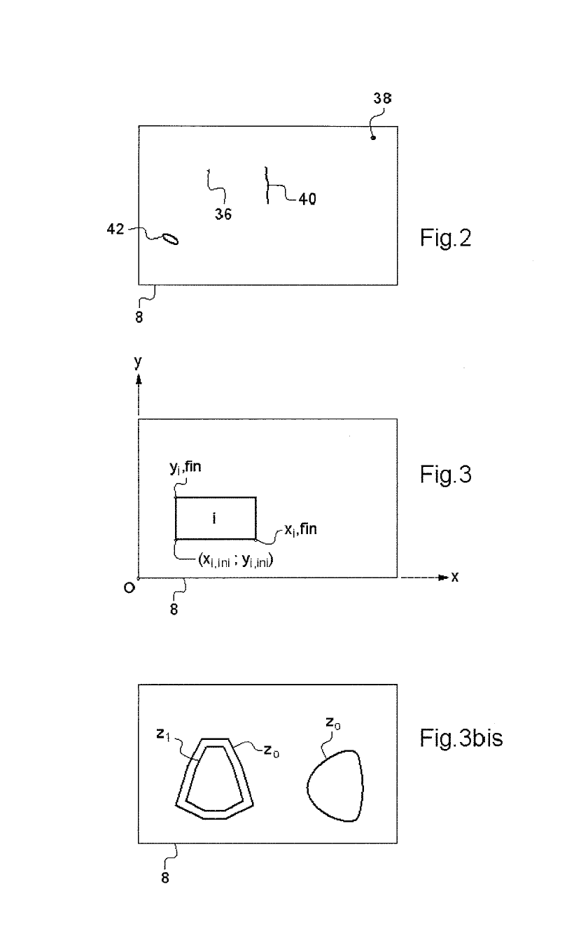

FIG. 2 represents in a schematic manner an example of motherglasses for which various defects have been cataloged;

FIG. 3 illustrates a possible implementation of the positioning of a piece to be cut (called a “primitive”) with a view to an optimization computation;

FIG. 3bis illustrates other possible shapes of pieces to be cut;

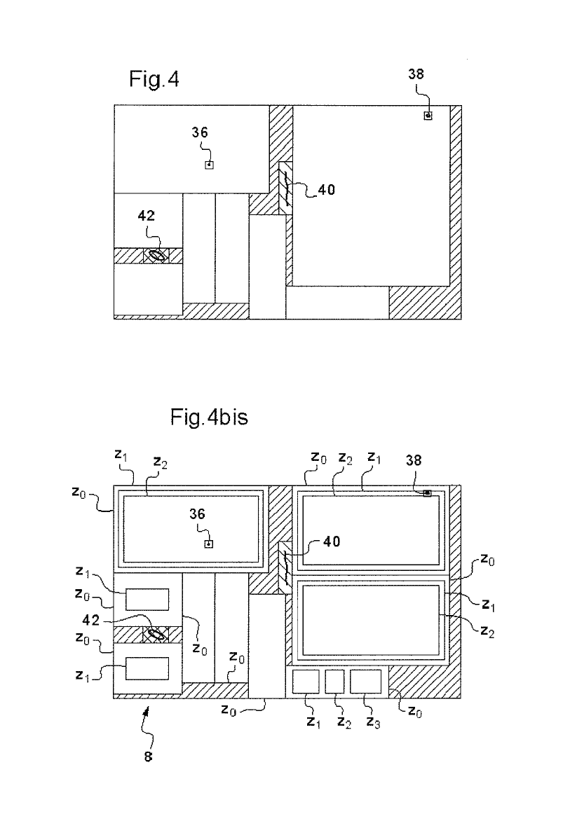

FIG. 4 represents in a schematic manner an example of a cutting layout in the motherglass of FIG. 2, the cutting layout being generated by a computer as a function of the information relating to the defects and as a function of acceptance criteria for allowing the defects;

FIG. 4bis is a figure analogous to FIG. 4, illustrating an exemplary optimization using acceptance criteria for the different defects for various zones of the pieces to be cut.

FIG. 1 is a nonlimiting example of a manufacturing process to which the various aspects of the invention may apply.

In this example, the upper part of the diagram relates to the steps of manufacturing a motherglass at the premises of a glass manufacturer, and the second part the steps of manufacturing an application glass such as a glass for automobile glazing, glazing for solar application, for example photovoltaic, glazing for OLED application, mirror or building glazing at the premises of a second manufacturer, a customer of the first.

All the steps can as a variant be carried out by one and the same manufacturer or the division of the work be of any suitable type.

In this particular example, the first manufacturer produces in a factory 2 so-called “float glass”, a continuous ribbon 4 of glass floated on a tin bath. Defects of the ribbon 4 are analyzed by a detection device 6 (of any suitable type), and then the ribbon 2 cut up into motherglass 8.

Note that the detection device is for example a device called a “scanner” in the industry and intended to analyze the glass to detect defects therein.

In a conventional manner, the zones, if any, of the ribbon exhibiting defects judged non-acceptable are for example excluded during the cutting of the motherglasses. We will nonetheless see hereinbelow that rejecting zones of ribbon between motherglasses is not necessary with the invention.

Information with regards to the defects relating to each motherglass is stored in a database 10. For this purpose, the defects are marked with an identifier 12, for example a bar code, an RFID chip or another means of any suitable type. The marking of the identifier is for example carried out with ink or by laser.

The stored information about defects includes for example the position, the size and the type of the defects detected by the detection device 6.

As a variant, the defects are not stored in this way, that is to say by writing to an electronic memory. They are for example marked by an ink on the defects of the glass, which ink will be for example thereafter read by a camera.

The term “store” must thus be understood in the broad sense, throughout the text, the marking of the defects by an ink being considered to be a storage of information relating to the defects, which information is inscribed on the glass.

The motherglasses are for example thereafter stacked 14 and stored 16 before being transported for a conversion process 18, for example for the deposition of a coating by a “coater”, typically at least one conducting or dielectric coating, transparent or reflecting, and exhibiting thicknesses of a few tens or hundreds of nanometers of thickness, or else for example for a process for lamination or formation of a mirror.

After treatment, the motherglasses are for example analyzed by a second detection device 20, with the aim notably of detecting defects in the treatment or treatments carried out.

The detection device 20 is for example a “scanner” such as mentioned hereinabove.

The detection device 20 is able to identify the motherglasses 8, for example by means of a bar code reader. It is furthermore for example linked to the database 10 so as to be able to use the stored information about defects for each motherglass, for example for more meticulous inspection of the zones exhibiting known defects, and so as to be able to store the new defects information generated by the detection device 20 for each motherglass 8 analyzed.

In the case where ink spots have been previously inscribed on the defects, the detection device 20 comprises for example in addition to or in replacement for the “scanner”, a camera detecting the position of the spots on entry to the conversion line.

The database 10 is optional. It may as a variant involve a removable memory medium read by the detection device 20 or a tool linked to the detection device 20.

The motherglasses 8 are again stacked 22 and stored 24, for example on the basis of the stored information about defects, before being transported 26 to a customer.

The customer will be the one to cut the motherglasses into pieces of glass, typically into several glass sheets exhibiting identical dimensions. Note that as a variant, it is not a customer but the first manufacturer himself, for example an in-house converter.

The customer possesses a computer tool 28 in which stored programs are able to provide an optimum cutting layout for example on groups of several motherglasses or on just one, with the aim of minimizing the quantity of glass that has to be rejected.

For this purpose, the customer has for example an identifier reader for identifying each motherglass 8 and has for example access to the database 10, which is for example linked to the computer tool 28 by an information system such as the Internet. The information is for example filtered by a filter 30, in such a way that only the information useful to the customer is accessible or in such a way that this information is accessible in a compatible format.

As a variant, notably in the case where ink spots have previously been inscribed on the defects of the glass, the customer is for example equipped with a camera detecting the position and/or the color and/or the size of the spots on entry to the cutting line and transmitting this information to the computer 28.

The programs of the computer will be described in greater detail hereinbelow, involving essential aspects of the invention.

Once the generation of an optimum cutting layout has been carried out, the motherglasses are cut 32 according to the cutting layouts that the computer 28 has selected for each motherglass 8.

As illustrated, the cut pieces are for example washed 34 before being optionally analyzed by a third detection device 36 and then for example assembled into a building multiple-glazing or into an automobile glazing.

In the case for example of a motor vehicle windshield, two pieces of glass will be bent and laminated together by way of a thermoplastic interlayer for example of PVB type.

The various aspects of the invention relating to the obtaining of an optimum cutting layout will be described in greater detail hereinbelow.

In a second part, we will mention possible generalizations of the example of FIG. 1 to other manufacturing processes.

As explained hereinabove, the invention relates more particularly to the dynamic generation of an optimum cutting layout.

According to a first aspect of the invention, this indeed involves generating in a dynamic manner an optimum cutting layout for each of the glass sheets as a function of the information relating to the defects which has been stored, the optimum being obtained by an iterative and automatic computation, for example by a linear optimization.

An exemplary dynamic generation process will be described hereinbelow.

FIG. 2 illustrates an example of motherglasses for which various defects have been cataloged, namely, a defect 36 of “pinhole” type on the coating, a defect 38 of bubble type, a defect 40 of scratch type on the glass, and a defect 42 of surface defect type.

Let us begin with the simplest example, namely the dynamic generation of an optimum cutting layout in a single glass sheet with pieces of glass to be cut of identical size, defects of a single type and of a single size and which are not accepted in the pieces of glass to be cut (or “primitives”).

This example is explained in relation to FIG. 3.

The dynamic generation is, in this example, carried out by a linear optimization, that is to say by iteratively solving an optimization problem for a linear function on a convex polyhedron representing constraints on the variables, the constraints being linear equations.

As a variant, it involves an optimization program based on dynamic computation of any suitable type. The advantage of linear programming is notably its speed of computation.

Furthermore, the program computes only a single cutting layout, which is known to be optimal.

The chosen objective is to minimize a function representative of the number of primitives including at least one defect.

We will see hereinbelow how the value of this function may be computed.

As a variant, the function provides a value representative of the number of pieces of glass cut in the cutting layout generated and/or of a sum of one or more dimensions of the cut pieces of glass such as the total surface area of the cut pieces of glass and/or of a sum of the retail costs of the cut pieces of glass.

In a general way, this involves a performance indicator for the cutting layout of any suitable type.

In this example, the pieces to be cut, also called “primitives” in the industry, are rectangles (see FIG. 3).

In a general way, this involves a polygon or even more generally still a closed figure (i.e. the edges are not necessarily rectilinear, see FIG. 3bis). The various aspects of the invention can of course apply to the cutting of the pieces of glass forming automobile glazings, which typically have non-rectilinear contours.

Note that the image is for example pixelized and that a polygon, be it a rectangle, a parallelogram or other, is then a combination of pixels.

For each primitive, here rectangles, two variables and two parameters are used here to define its positioning with respect to the motherglass. Indeed, in this example the rectangles always have the same orientation, that is to say an orientation with the length parallel to the length of the motherglasses.

As illustrated in FIG. 3, the coordinates with abscissae x_{i,ini} and ordinates y_{i,ini} for example of the lower left corner of each primitive i are for example chosen as variables to represent the position of each rectangle.

As a variant, this involves another point of the primitive or other types of coordinates. As a further variant, the variables indicate an angle of the primitive with respect to a reference, so as to be able to rotate the primitive during optimization.

In a general manner, this involves variables giving an indication of positioning of the primitive with respect to the motherglass to be cut.

The two parameters (constant by definition) chosen here are the length and the width of the rectangle, which make it possible to compute, on the basis of the coordinates of the lower left corner of the piece to be cut, the ordinate y_{i,end} of the upper left corner and the abscissa x_{i,end} the lower right corner.

As a variant, these are parameters of any type suitable for indicating the dimensions or the orientation of the primitive.

A constraint of intersection of two primitives is introduced. In this example, the constraint “Intersection (i, j)” of two primitives is equal to 1 if two primitives overlap and equal to 0 in the converse case. This constraint must of course be equal to 0. These values are for example stored in an n×n matrix, n being an integer corresponding to the number of primitives that it is desired ideally to be able to cut from the sheet.

Intersection (i, i) is of course not considered.

In this example, Intersection( ) contains in fact 4 constraints, namely
x_{i,ini}≧x_{j,end} y_{i,ini}≧y_{j,end}
x_{j,ini}≧x_{i,end} y_{j,ini}≧y_{i,end}

At least one of these four constraints must be satisfied in order that the constraint Intersection (i,j) be equal to 0.

Finally, the value of the function is computed by creating a matrix of n rows and m columns, m being an integer corresponding to the number of defects.

Each defect is defined by a rectangle whose positioning is defined for example in the same manner as the primitives, namely with x_{i,ini},y_{i,ini}, x_{j,end} and y_{j,end}.

In the same manner as for the primitives, it more generally involves a closed figure of any suitable type, for example a polygon.

A function Defect (i,j)=1 in the case of intersection of the primitive rectangle i with the defect rectangle j and equal to 0 in the converse case by satisfaction of at least one of the four inequalities mentioned hereinabove for the constraint Intersection( ).

In contradistinction to Intersection (i,j), Defect (i,j) is not a constraint but a value serving for the computation of the objective function to be maximized.

The computer thereafter computes

$${\sum }_{j}^{ } Defect ( i , j )$$

for each primitive i.

A table of size n is created with the values IsGood(i).

$$IsGood ( i ) = 0 if {\sum }_{j}^{ } Defect ( i , j ) \geq 1 , \\ and$$

$$IsGood ( i ) = 1 if {\sum }_{j}^{ } Defect ( i , j ) = 0.$$

$$The objective function = {\sum }_{i}^{ } IsGood ( i ) ,$$

which must be maximized.

To implement this program, a linear solver using a simplex algorithm is for example used.

Initially an initial cutting layout has been recorded in memory.

The iterations are carried out on the basis of this initial cutting layout, for which the function to be optimized is computed during a first initialization step.

Several generalizations of this program will be explained hereinbelow.

Firstly, linear programming is merely one possibility from among others for generating an optimum cutting layout by dynamic computation, as is the manner of posing the problem to be solved and of solving it.

In a general way, it involves an automatic optimization process using dynamic computation.

It involves for example a dynamic computation which maximizes or minimizes a function of several variables, the variables being subject to constraints. The function might not be linear, nor might the equations induced by the constraints.

Another possibility for extending the example hereinabove is to consider primitives of various sizes and/or with various orientations. One expedient, for rectangle primitives, consists in considering to be variables, in addition to the coordinates (x_{i,ini}, y_{i,ini}) of the lower left corner, the length and the width so as to determine the size, and an angle of orientation of the rectangle so as to determine the orientation.

It is also possible to generate an optimum cutting layout by envisaging a possible positioning of various primitives on various glass sheets. The glass sheets are then for example considered to be contiguous and forming a single glass sheet. Overlap of the primitives with the junctions between sheets are for example prohibited by considering the intersection with these junctions as a prohibited constraint.

This is for example of interest in the case of primitives of various sizes, so as to comply with ideal guidelines for the distribution of these various types of primitives.

Compliance with the guidelines is for example integrated into the objective function or considered to be a constraint.

As a further variant, the optimization may be carried out for several acceptance criteria for allowing the defects.

The types of the defects and the acceptance of these defects for each type of primitive are then for example parameters taken into account by the program. The computation of Defect (i, j) then takes account of these parameters. The value of Defect (i, j) will be for example equal to 0 in the case of intersection with defects of acceptable type for the primitive considered. The acceptance criteria are for example different for various pieces of glass to be cut and/or various motherglasses. FIG. 4 illustrates an example of an optimum cutting layout in which the defects 36 and 38 are considered acceptable for the pieces of glass concerned, while the defects 40 and 42 are not acceptable for any of the pieces to be cut.

According to a particular variant, the primitives are divided into various zones corresponding to different acceptance criteria for allowing the defects, so as to provide an optimum cutting layout as a function of different defects acceptance criteria for various zones of the pieces to be cut.

The advantage of this is to make it possible to yet further optimize the process for cutting pieces of glass from a glass sheet of large dimensions or from a group of several glass sheets.

Indeed, taking account of information relating to the defects, notably their position, their type and their size, makes it possible to discriminate between defects that have to be rejected or accepted according to the zone of the piece to be cut in which the defects are situated.

A possible implementation of this variant for dynamic generation of the optimum cutting layout is described hereinbelow.

As illustrated in FIG. 4 bis, the various defects acceptance zones are for example rectangles included one in the other inside the piece to be cut.

The positioning of each zone inside the primitive (z1 and z2 in FIG. 4) is for example defined by four parameters, namely for example the relative coordinates of its lower left corner with respect to the lower left corner of the primitive, its length and its width.

These four parameters make it possible to compute, on the basis of the coordinates of the lower left corner of the primitive, the coordinates with abscissae x_{i,z1,ini} (for zone z1) and with ordinates y_{i,z1,ini}, the ordinate y_{i,z1,end} of the upper left corner and the abscissa x_{i,z1,end} of the lower right corner.

The same holds for zone z2 inside zone z1.

Furthermore, the number of zones in a primitive is for example an additional parameter of the primitive.

To determine whether a defect is in at least one of the zones, the “Defect” function described hereinabove may be adapted in the following manner.

Acceptance criteria for allowing the defects for the various zones are for example defined as additional parameters of each zone.

Furthermore, the defects are for example attributes of the parameters such as their size or their type (bubble, scratch, etc) making it possible to accept them differently in each zone. This is not, however, necessary in the simplest case where each zone accepts either all the defects taken into account, or none.

For example, we will have for example a DefectPosition function with, for example for zone z1:

DefectPosition(i,z1,j)=1 in the case of intersection of the zone z1 rectangle with the defect j rectangle and equal to 0 in the converse case by satisfaction of at least one of four inequalities analogous to those mentioned hereinabove for the intersection of the primitives. This function verifies the presence of the defect in the zone.

If DefectPosition(i,z1,j)=1, it is satisfied if the acceptance criteria for zone z1 are compatible with this defect, we then have for example DefectZone(i,z1,j)=0 in the case of compatibility, and DefectZone(i,z1,j)=1 in the converse case.

This is carried out for each zone z1, z2, . . . inside the primitive and for the rectangle of the primitive, which corresponds to the zone “z0”.

We will then have

$$Defect ( i , j ) = 1 if {\sum }_{z}^{ } DefectZone ( i , z , j ) \geq 1$$

(i.e. DefectZone(i,z0,j)+DefectZone(i,z1,j)+DefectZone(i,z2,j)+ . . . ≧1), and

$$Defect ( i , j ) = 0 if {\sum }_{z}^{ } DefectZone ( i , z , j ) = 0.$$

The program thereafter proceeds in the same manner as described hereinabove for the computation of the objective function.

To discriminate on the size or the type of defect, the computation will for example be undertaken, in the case where DefectPosition(i,z1,j)=1, of DefectType( ) and DefectSize( ) with for example:

DefectType(i,z1,j)=1 if the type is not accepted for zone z1 and 0 in the converse case, and

DefectSize(i,z1,j)=1 if the type is not accepted for zone z1 and 0 in the converse case. More precisely, it is also possible to verify the size solely for the part of the defect inside the zone z1.

Thereafter, if DefectType(i,z1,j)=1 or DefectSize(i,z1,j)=1 then DefectZone(i,z1,j)=1, and

DefectZone(i,z1,j)=0 in the converse case.

The program thereafter proceeds in the same manner as described hereinabove for the computation of the objective function.

Furthermore, as explained above, the various aspects of the invention can apply to numerous glass manufacturing processes.

The example of FIG. 1 may be generalized to manufacturing processes of any suitable type.

Firstly, the number of steps of defects analysis is of any suitable type. An advantage of the identification of the motherglasses 8 or of the marking of the defects with ink is to make it possible to carry out these various analyses independently, each detection device then being for example provided with one or more readers for identifying the motherglasses and linked to the database 10.

As regards the identifier, notably in the case of a marking of the identifier, this will advantageously involve a marking on the rim of the motherglasses, so that the latter can be easily read once stacked.

Rather than identifying each motherglass and having a database for storing the information about defects, it is possible, as a variant, as mentioned previously, to mark the defects with an ink of such and such a color and/or size on the defect itself.

The customer is then capable of identifying the various types of defects, their size and their position and can, for example with automatic readers, for example cameras, itself generate information about defects which is useful to the program for optimizing the cutting layouts.

It should also be noted that the relative steps relating to the conversion of the glass sheets are optional since certain sheets are not treated before cutting.

Another aspect of the process of FIG. 1 relates to the place and moment of optimization.

In the process of FIG. 1, the optimization of the cutting is carried out at the customer's premises, that is to say at the cutter's premises. Nonetheless, this optimization can of course be carried out at the premises of the manufacturer of the motherglass, insofar as the information relating to the pieces of glass to be cut and the acceptance criteria for allowing the defects are known to him. This optimization at the premises of the motherglass manufacturer will be all the more advantageous as it will allow him to carry out cutting optimizations on larger numbers of motherglasses for example by grouping together motherglasses intended for various customers.

In this way, instead of sending motherglasses judged to be in accordance with guidelines to such and such a customer, without taking account of an optimization of the cutting at the customer's premises, the dispatching of the motherglasses to the various customers may be distributed as a function of the results of the optimization, thereby avoiding sending a customer a motherglass which will not be optimum whereas this motherglass would have been more optimum to be cut at another customer's premises.

The motherglass manufacturer can also of course undertake a first cutting of a motherglass for example to send one part thereof to a first customer and the other part to a second customer, the customers performing a second cutting from these pieces.

1. A process for cutting several pieces of glass from at least one glass sheet, comprising:
reading information relating to defects in said at least one glass sheet;
automatically generating an optimum cutting layout for each of said at least one glass sheet as a function of at least some of the information relating to the defects, the automatic generation of the optimum cutting layout being obtained by dynamic computation;
cutting the pieces of glass complying with the optimum cutting layout generated.

2. The process as claimed in claim 1, wherein the dynamic computation maximizes or minimizes an objective function of several variables, the variables being subject to constraints, and the computation generating only a single cutting layout.

3. The process as claimed in claim 2, wherein the objective function provides a value representative of the number of pieces of glass to be cut which includes at least one non-acceptable defect and/or is representative of a sum of one or more dimensions of the pieces of glass and/or is representative of a sum of the costs of rejecting the pieces of glass.

4. The process as claimed in claim 2, wherein the variables include variables representative of spatial coordinates of the pieces to be cut.

5. The process as claimed in claim 2, wherein certain of the pieces to be cut have different dimensions, the variables including variables representative of one or more dimensions of at least some of the pieces to be cut.

6. The process as claimed in claim 2, wherein the variables include variables representative of one or more angles of at least some of the pieces of glass to be cut with respect to one or more references.

7. The process as claimed in claim 2, wherein the variables and/or the constraints include respectively variables and/or constraints representative of acceptance criteria for allowing the defects as a function of at least some of the information about the defects.

8. The process as claimed in claim 2, wherein the acceptance criteria for allowing defects are different inside a predetermined zone of one, of several or of each of the pieces to be cut with respect to another predetermined zone of the same piece to be cut.

9. The process as claimed in claim 2, wherein said at least one glass sheet comprises several glass sheets, the variables including at least one variable representative of a cutting percentage for at least one of the pieces from the group of glass sheets.

10. The process as claimed in claim 2, wherein the constraints include at least one constraint of positioning of the pieces of glass preventing the mutual overlap of the pieces of glass.

11. The process as claimed in claim 2, wherein the constraints include at least one constraint of positioning of the pieces of glass inside at least one of the glass sheet or sheets.

12. The process as claimed in claim 1, comprising:
analyzing the defects in said at least one glass sheet;
storing information relating to the defects detected in said at least one glass sheet, the storage being carried out notably by marking with ink on the defects of said at least one glass sheet or by storage in an electronic memory, the reading of the information including reading an ink marked on the defects of the glass or reading an electronic memory containing said information.

13. The process as claimed in claim 1, wherein the information relating to the defects includes a position and/or a size and/or a type of the defects.

14. The process as claimed in claim 5, wherein the variables include a width and/or length of a rectangle shaped piece.

15. The process as claimed in claim 7, wherein the acceptance criteria for allowing the defects is different for various pieces of glass to be cut.
